(19) United States
(12) Patent Application Publication
(10) Pub. No.: US 2004/0222743 A1
(43) Pub. Date: Nov. 11, 2004

(54) Dielectric barrier discharge type low-pressure discharge lamp

(75) Inventors: Masami Takagi, Imabari-shi (JP); Yuji Takeda, Imabari-shi (JP); Takayoshi Kurita, Imabari-shi (JP); Tomomasa Hirao, Imabari-shi (JP)

Correspondence Address: BANNER & WITCOFF, 1001 G STREET N W, SUITE 1100, WASHINGTON, DC, 20001, US

(73) Assignee: Harison Toshiba Lighting Corporation, Ehime (JP)

(21) Appl. No.: 10/798,260

(22) Filed: Mar. 12, 2004

Related U.S. Application Data
(63) Continuation-in-part of application No. PCT/JP03/07679, filed on Jun. 17, 2003.

(30) Foreign Application Priority Data
Mar. 13, 2003 (JP) 2003-68547

(51) Int. Cl. H01J 1/62; H01J 63/04

(52) U.S. Cl. 313/634; 313/493

(57) ABSTRACT

A tubular glass lamp vessel 10 composing a dielectric barrier discharge type low-pressure discharge lamp is provided with electrically conductive layers 31, 36 as electrodes on an outer surface of at least one end of the tubular glass lamp vessel 10. The electrically conductive layers 31, 36 are formed on the surface of the tubular glass lamp vessel 10 by solder material. A metal strip 106 for electric supply is fixed by soldering on the electrically conductive layers 31, 36.

### FIELD OF THE INVENTION

This is a continuation-in-part of Application PCT/JP03/07679, filed on Jun. 17, 2003 including U.S.A. as a designated country, the specification of which is hereby incorporated by reference.

The present invention relates generally to a dielectric barrier discharge type low-pressure discharge lamp, and in particular, to a connecting structure of an electric supply wire to an electrode.

### BACKGROUND OF THE INVENTION

Conventionally, a dielectric barrier discharge type low-pressure discharge lamp provided with electrodes on the outer surface of a tubular glass lamp vessel is already known. The conventional dielectric barrier discharge type low-pressure discharge lamp is provided with a tubular glass lamp vessel, both ends of which are sealed. Inside the tubular glass vessel, an ionizable filling material such as a rare gas or a mixed gas of rare gas and mercury is enclosed. On an inner surface of the tubular glass lamp vessel, a phosphor layer is formed if necessary. On an outer surface of both ends of the tubular glass lamp vessel, a pair of external electrodes is provided.

The external electrodes are composed of, for example, metal tapes composed of aluminum foil adhered on the outer surface of both ends of the tubular glass lamp vessel through an electrically-conductive adhesive. These external electrodes make contact with fuse holder type electric supply members, which are connected with the electric lead wires. The fuse-holder type electric supply member is composed of a ring-shaped metal strip, which makes contact with the external electrode due to spring elasticity of the metal strip. The electric lead wire is provided with a high frequency voltage from a lighting device (not illustrated).

A plurality of low-pressure discharge lamps described above can be operated simultaneously by being connected in parallel with a common lighting device due to the fact that current vs. voltage characteristic is positive, which makes designing of the lighting device easier.

However, in conventional dielectric barrier discharge type low-pressure discharge lamps, the electric supply metal strip is electrically connected with the external electrodes through mechanical contact between them. Therefore, it was difficult to maintain a good electric contact between the metal strip and the surface of the external electrode. As a result, the electric resistance between the external electrode and the electric supply metal strip becomes higher, resulting in higher voltage supply or loss of electric power.

Further, the conventional electric supply metal strip has a drawback that it has a large and complicated construction, which requires a higher cost.

To solve such problems, there may be an idea to connect the lead wire to the external electrodes by soldering instead of using electric supply metal strip, which is a mechanical connecting measure. However, the electrical connection by soldering needs higher skill, because the external electrodes are made of aluminum with an electrically-conductive adhesive.

The present invention was made to overcome these conventional technical problems. Therefore, it is an object of the present invention to supply a dielectric barrier discharge type low-pressure discharge lamp having a simplified structure of electric supply with good electric conductivity and low cost.

### BRIEF SUMMARY OF THE INVENTION

The dielectric barrier discharge type low-pressure discharge lamp according to the present invention is provided with a tubular glass lamp vessel. A current conductor layer is provided as an electrode on the outer surface of at least one end of the tubular glass lamp vessel. The current conducting layer is formed on the surface of the tubular glass lamp vessel with a solder material. A metal member for electric supply is fixed on the current conductor layer by soldering.

A drive voltage from a high frequency power supply source is supplied to the metal member through the lead wire soldered on the surface of the metal member. The drive voltage is thus supplied to the external electrode of the discharge lamp without power loss.

Further, in the dielectric barrier discharge type low-pressure discharge lamp according to the present invention, the major component of the solder material is one of tin, an alloy of tin and indium, or an alloy of tin and bismuth, and the current conductor layer is formed by dipping the solder material into an ultrasonic solder tub.

Further, in the dielectric barrier discharge type low-pressure discharge lamp according to the present invention, the metal member is a metal strip.

According to the present invention, an electric supply portion can be formed by connecting a lead wire with the metal strip by soldering. Thus, the assembly of the electric supply portion can be made simple.

Further, in the dielectric barrier discharge type low-pressure discharge lamp according to the present invention, the metal member is a metal wire, which is wound around the current conductor layer like a coil and is soldered with the layer.

That is, the electric supply portion can be constructed by soldering an electric supply lead wire with the coil-shaped metal wire which is soldered on the external electrode side. Thus, it can be manufactured by such a simple process that a metal wire is wound around the external electrode portion in a coil shape and is soldered.

Besides, a stable electric supply for a long time can be expected, because current is not concentrated at a particular point due to the coil-shaped metal wire.

Further, in the dielectric barrier discharge type low-pressure discharge lamp according to the present invention, the electric supply portion for external electrode has more simple construction, in which the core wire of the lead wire is attached to the current conductor layer by soldering and thus reduction in the manufacturing cost is possible.

### BRIEF DESCRIPTION OF THE DRAWINGS

FIG. 1 is a cross section of a dielectric barrier discharge type low-pressure discharge lamp, which is a first embodiment of the present invention.

FIG. 2 is a cross section of a dielectric barrier discharge type low-pressure discharge lamp, which is a second embodiment of the present invention.

FIG. 3 is a cross section of a dielectric barrier discharge type low-pressure discharge lamp, which is a third embodiment of the present invention.

FIG. 4 is a cross section of a dielectric barrier discharge type low-pressure discharge lamp, which is a fourth embodiment of the present invention.

FIG. 5 is a cross section of a dielectric barrier discharge type low-pressure discharge lamp, which is a fifth embodiment of the present invention.

### DETAILED DESCRIPTION OF THE INVENTION

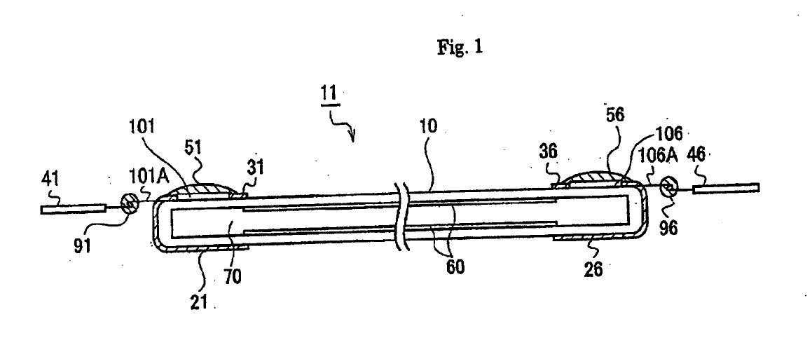

Hereinafter, embodiments of the present invention will be explained in detail according to the figures. FIG. 1 shows a construction of a dielectric barrier discharge type low-pressure discharge lamp 11 according to the first embodiment of the present invention. As shown in FIG. 1, a tubular glass lamp vessel 10 with both ends sealed is provided in the dielectric barrier discharge type low-pressure discharge lamp 11. Inside the tubular glass lamp vessel 10, an ionizable filling material 70 such as rare gas or a mixed gas of rare gas and mercury is enclosed. On an inner surface of the tubular glass lamp vessel 10, a phosphor layer 60 is formed.

On an external surface of both ends of the tubular glass lamp vessel 10, external electrodes 21, 26 are formed. The external electrodes 21, 26 are produced by dipping the end portion of the tubular glass lamp vessel 10 into a solder tub (not illustrated), in which molten solder is stored and ultrasonic vibration is applied to the molten solder.

Here, the major component of the solder material molten in the solder tub is one of the following: tin, alloy of tin and indium, or alloy of tin and bismuth. Further, when at least one selected from the group: antimony, zinc, and aluminum is added to the solder material as additives, much better solder material can be obtained.

Further, by adding blast treatment on the external surface of both ends of the tubular glass lamp vessel 10 before it is dipped in molten solder tub, the solder material can be fixed more tightly with the external surface of the vessel.

Metal strips 101, 106 each having connecting ends 10A, 106A are arranged on the solder layer composing the external electrodes 21, 26 built in this way, and are fixed by ultrasonic soldering 51, 56. Next, lead wires 41, 46 are entwined with the connecting ends 10A, 106A of the metal strips 101, 106 respectively and connected by soldering. A high frequency voltage is supplied through the lead wires 41, 46 from a lighting device (not illustrated), and the low-pressure discharge lamp 11 is lighted.

In the first embodiment, electric supply from lighting device is possible by connecting metal strips 101, 106 with the external electrodes 21, 26 by soldering, and by connecting lead wires 41, 46 with the connecting ends 10A, 106A of the metal strips 101, 106. Therefore, the electric connection between the lead wire 41, 46 and the external electrode 21, 26 can be attained by the soldering with keeping high conductivity and high mechanical strength. Besides, the structure of this electric supply is very simple, enabling the reduction of manufacturing cost and enabling the reduction of size compared with the conventional fuse holder type electric supply member.

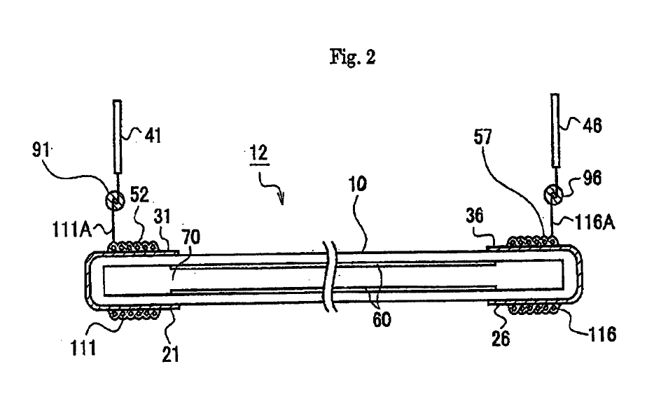

Next, the second embodiment of the present invention will be explained with reference to FIG. 2. A dielectric barrier discharge type low-pressure discharge lamp 12 of the present embodiment is provided with a tubular glass lamp vessel 10 similar to one in the first embodiment. On the external electrodes 21, 26 of the external periphery of both ends of the lamp vessel 10, coil-shaped metal wires 111, 116 are formed by a metal wire wound around external electrodes 21, 26 in a coil shape and are fixed to them by ultrasonic soldering 52, 57. Electric supply portions are formed by entwining with lead wires 41, 46 and by soldering 91, 96 at each connecting ends 111A, 116A of coil-shaped metal wires 111, 116. A high frequency voltage is supplied through these lead wires 41, 46 from a lighting device, and low-pressure discharge lamp 12 is lighted.

In the dielectric barrier discharge type low-pressure discharge lamp 12 according to the present embodiment, the electric supply portion can be built by winding metal wire in a coil shape around the external electrode portion and by soldering it. Further, a long term stable electric supply characteristics can be expected because the current is not concentrated at a particular point due to the function of the coil-shaped metal wire.

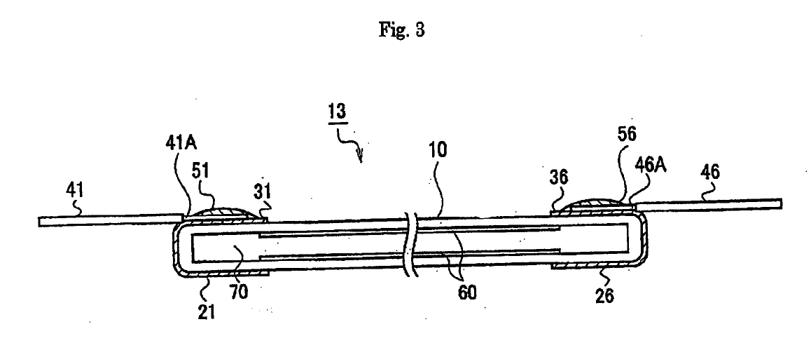

Next, the third embodiment of the present invention will be explained with reference to FIG. 3. In the present embodiment, core wires 41A, 46A of lead wires 41, 46 are connected with external electrodes 21, 26 by ultrasonic soldering 51, 56. The structure of a tubular glass lamp vessel 10 is similar to the one in the first embodiment.

According to the third embodiment, there is no need to attach separate parts by soldering on the external electrodes 21, 26 of the tubular glass lamp vessel. Instead, it only needs to solder the core wire 41A, 46A of the lead wire 41, 46 on the external electrodes 21, 26 by ultrasonic soldering. Since the structure is simple, further reduction in cost and size is possible.

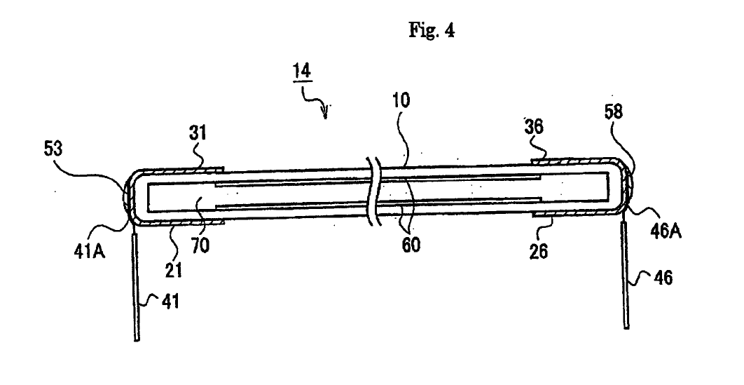

Next, the fourth embodiment of the present invention will be explained with reference to FIG. 4. In the present embodiment, the core wires 41A, 46A of the lead wires 41, 46 are connected directly by ultrasonic soldering at the top end portion of each of external electrodes 21, 26 at both ends of tubular glass lamp vessel 10. The other configurations are similar to those in the third embodiment shown in FIG. 3.

Also in the fourth embodiment, the structure of the electric supply portion is simple as with the case in third embodiment, the size and the manufacturing cost can be reduced a great deal.

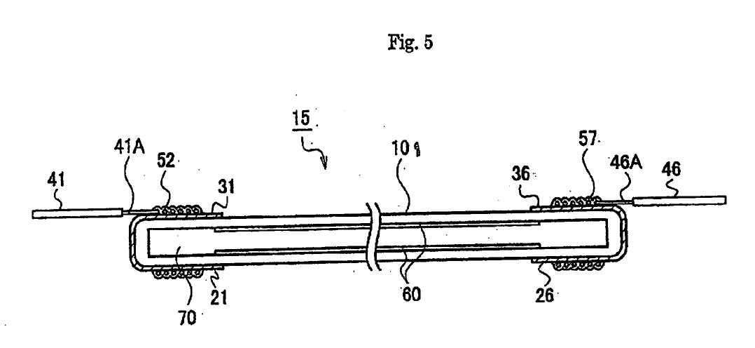

Next, the dielectric barrier discharge type low-pressure discharge lamp 15 in the fifth embodiment of the present invention will be explained with reference to FIG. 5. In the present embodiment, the core wires of the lead wires 41, 46 are stripped at a long portion. Each of the core wires 41A, 46B is wound around the outer periphery of the external electrode 21, 26 at each end of the tubular glass lamp vessel 10, and is connected directly with the external electrodes 21, 26 by ultrasonic soldering 52, 57. The other constructions are similar to those in the third embodiment shown in FIG. 3.

In the present embodiment, the construction is simple similarly with the third embodiment and the cost can be reduced. The core wires 41B, 46B of the lead wires 41, 46 are wound around the external electrodes 21, 26 in a coil shape and fastened by soldering, so the joined portions are strong and can maintain a stable performance for a long time because the current does not concentrate in a particular point.

Here, in the above mentioned embodiments, only the cases when the external electrodes 21, 26 are provided on the both ends of the tubular glass lamp 10, have been explained. However, the present invention can be applied similarly to a dielectric barrier discharge type low-pressure discharge lamp in which an external electrode is provided only on one end of a tubular glass lamp 10.

1. A dielectric barrier discharge type low-pressure discharge lamp comprising a tubular glass lamp vessel which is provided with an electrically conductive layer as an electrode on an outer surface of at least one end portion of the lamp vessel;
wherein the electrically conductive layer is composed of solder material on the surface of the lamp vessel, and a metal member for electric power supply is attached on the electrically conductive layer by soldering.

2. A dielectric barrier discharge type low-pressure discharge lamp according to claim 1, wherein the major component of the solder material is one selected from the group consisting of tin, an alloy of tin and indium, and an alloy of tin and bismuth, and the electrically conductive layer is formed by dipping the solder material in an ultrasonic solder tub.

3. A dielectric barrier discharge type low-pressure discharge lamp according to claim 1, wherein the metal member is a metal strip.

4. A dielectric barrier discharge type low-pressure discharge lamp according to claim 2, wherein the metal member is a metal wire which is wound around the electrically conductive layer in a coil shape and attached by soldering.

5. A dielectric barrier discharge type low-pressure discharge lamp according to claim 1, wherein the metal member is a metal wire which is wound around the electrically conductive layer in a coil shape and attached by soldering.

6. A dielectric barrier discharge type low-pressure discharge lamp according to claim 2, wherein the metal member is a metal wire which is wound around the electrically conductive layer in a coil shape and attached by soldering.

7. A dielectric barrier discharge type low-pressure discharge lamp comprising a tubular glass lamp vessel which is provided with an electrically conductive layer as an electrode on an outer surface of at least one end portion of the lamp vessel;
wherein the electrically conductive layer is composed of solder material on the surface of the lamp vessel, and a core wire of a lead wire is attached by soldering on the electrically conductive layer.

8. A dielectric barrier discharge type low-pressure discharge lamp according to claim 2, wherein the major component of the solder material is one selected from the group consisting of: tin, an alloy of tin and indium, and an alloy of tin and bismuth, and the electrically conductive layer is formed by dipping the solder material into an ultrasonic solder tub.
